(19) United States
(12) Patent Application Publication
(10) Pub. No.: US 2021/0044324 A1
(43) Pub. Date: Feb. 11, 2021

(54) COMMUNICATION SYSTEM AND SIGNAL REPEATER

(71) Applicant: MITSUBISHI ELECTRIC CORPORATION, Tokyo (JP)

(72) Inventors: Yusuke SUZUKI, Tokyo (JP); Hiroshi ITAKURA, Tokyo (JP); Tetsu OWADA, Tokyo (JP)

(73) Assignee: MITSUBISHI ELECTRIC CORPORATION, Tokyo (JP)

(21) Appl. No.: 16/964,920

(22) PCT Filed: Feb. 27, 2018
(86) PCT No.: PCT/JP2018/007307

§ 371 Date: Jul. 24, 2020

(51) Int. Cl. H04B 3/36

(52) U.S. Cl. CPC H04B 3/36

(57) ABSTRACT

A communication system is configured to include a signal repeater that demodulates transmission data on the basis of a first and a second pulse outputted from a transmitter to a transmission line, reproduces the first pulse as a pulse synchronized with a rise of the demodulated transmission data, reproduces the second pulse as a pulse synchronized with a fall of the demodulated transmission data, and outputs each of the reproduced first pulse and the reproduced second pulse to a transmission line.

### TECHNICAL FIELD

The invention relates to a communication system in which a signal repeater is inserted in the middle of a transmission line that connects a transmitter to a receiver, and a signal repeater inserted in the middle of a transmission line that connects a transmitter to a receiver.

### BACKGROUND ART

The following Patent Literature 1 discloses a balanced transmission connector including an equalizer circuit that shapes the waveform of a signal attenuated by a balanced transmission cable into the waveform of a pre-attenuated signal.

### CITATION LIST

### Patent Literatures

Patent Literature 1: JP 2005-235516 A

### SUMMARY OF INVENTION

### Technical Problem

The equalizer circuit included in the conventional balanced transmission connector is a circuit that compensates for transmission loss in the balanced transmission cable to enable long-distance transmission of signals.

However, it is difficult for the equalizer circuit to completely compensate for transmission loss in the balanced transmission cable, and particularly, compensation in high-frequency bands is incomplete.

Therefore, there is a problem that even if the equalizer circuit is provided, depending on the frequency of a signal transmitted by the balanced transmission cable, a receiving end device connected to the balanced transmission cable may erroneously demodulate the received signal.

The invention is made to solve a problem such as that described above, and an object of the invention is to obtain a communication system capable of reducing erroneous demodulation of signals even if the line length of a transmission line between a transmitter and a receiver is increased.

In addition, an object of the invention is to obtain a signal repeater implemented in a communication system capable of reducing erroneous demodulation of signals even if the line length of a transmission line is increased.

### Solution To Problem

In a communication system according to the invention, a signal repeater is inserted in a middle of a transmission line that connects a transmitter to a receiver, and the transmitter generates, as a pulse synchronized with a rise of transmission data having a pulse waveform, a first pulse having a narrower pulse width than a pulse width of the pulse waveform and having a positive signal level, generates, as a pulse synchronized with a fall of the transmission data, a second pulse having a narrower pulse width than the pulse width of the pulse waveform and having a negative signal level, and outputs each of the first pulse and the second pulse to the transmission line, the signal repeater demodulates the transmission data on the basis of the first and second pulses outputted from the transmitter to the transmission line, reproduces the first pulse as a pulse synchronized with a rise of the demodulated transmission data, reproduces the second pulse as a pulse synchronized with a fall of the demodulated transmission data, and outputs each of the reproduced first pulse and the reproduced second pulse to the transmission line, and the receiver demodulates the transmission data on the basis of the first and second pulses outputted from the signal repeater to the transmission line.

### Advantageous Effects of Invention

According to the invention, a communication system is configured to include a signal repeater that demodulates transmission data on the basis of a first and a second pulse outputted from a transmitter to a transmission line, reproduces the first pulse as a pulse synchronized with a rise of the demodulated transmission data, reproduces the second pulse as a pulse synchronized with a fall of the demodulated transmission data, and outputs each of the reproduced first pulse and the reproduced second pulse to a transmission line. Therefore, the communication system according to the invention can reduce erroneous demodulation of signals even if the line length of a transmission line between a transmitter and a receiver is increased.

### BRIEF DESCRIPTION OF DRAWINGS

FIG. 1 is a configuration diagram showing a communication system of a first embodiment.

FIG. 2 is an explanatory diagram showing the waveforms of signals handled by a transmitter 1.

FIG. 3 is an explanatory diagram showing first pulses P1 and second pulses P2 having a rounded waveform due to transmission loss on transmission lines 4a.

FIG. 4 is an explanatory diagram showing a demodulation process of transmission data T by a comparator 22.

FIG. 5 is an explanatory diagram showing the waveforms of signals handled by a narrow pulse generator circuit 23 of a signal repeater 2.

FIG. 6 is an explanatory diagram showing first pulses P1 and second pulses P2 having a rounded waveform due to transmission loss on transmission lines 4b.

FIG. 7 is an explanatory diagram showing transmission data T outputted from a comparator 32.

FIG. 8 is a configuration diagram showing another narrow pulse generator circuit 12 of the transmitter 1.

FIG. 9 is a configuration diagram showing another narrow pulse generator circuit 23 of the signal repeater 2.

FIG. 10 is an explanatory diagram showing the waveform of an input signal and the waveform of an output signal at each of the narrow pulse generator circuit 12 and the narrow pulse generator circuit 23.

FIG. 11 is a configuration diagram showing a communication system of a second embodiment.

### DESCRIPTION OF EMBODIMENTS

To describe the invention in more detail, modes for carrying out the invention will be described below with reference to the accompanying drawings.

### First Embodiment.

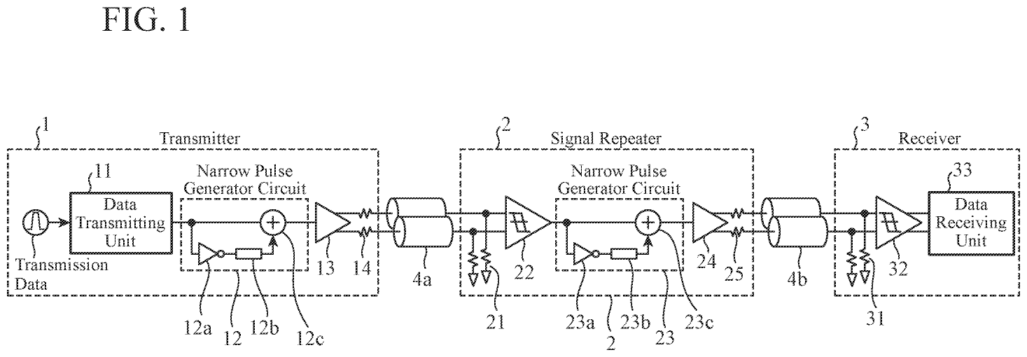

FIG. 1 is a configuration diagram showing a communication system of a first embodiment.

The communication system shown in FIG. 1 includes a transmitter 1, a signal repeater 2, and a receiver 3.

The transmitter 1 and the signal repeater 2 are connected to each other by transmission lines 4a, and the signal repeater 2 and the receiver 3 are connected to each other by transmission lines 4b.

For each of the transmission lines 4a and the transmission lines 4b, metal cables, printed circuit board wiring, or the like, are applied.

Although the metal cables have larger transmission loss than optical fiber cables, since the metal cables have advantages such as lower cost and easier maintenance than the optical fiber cables, the metal cables are applied to communication systems in some cases.

An example in which each of the transmission line 4a and the transmission line 4b is differential lines and transmits differential signals is shown in the communication system shown in FIG. 1. However, this is merely an example, and the communication system may be configured in such a manner that each of the transmission line 4a and the transmission line 4b is a single-ended line and transmits a single-ended signal.

The transmitter 1 includes a data transmitting unit 11, a narrow pulse generator circuit 12, an amplifier 13, and output resistors 14.

The transmitter 1 generates, as a pulse synchronized with a rise of transmission data T having a pulse waveform, a first pulse P1 having a narrower pulse width than a pulse width Tp of the pulse waveform and having a positive signal level.

In addition, the transmitter 1 generates, as a pulse synchronized with a fall of the transmission data T, a second pulse P2 having a narrower pulse width than the pulse width Tp of the pulse waveform and having a negative signal level.

The transmitter 1 outputs each of the first pulse P1 and the second pulse P2 to the transmission lines 4a.

When transmission data having a pulse waveform is provided to the data transmitting unit 11, the data transmitting unit 11 outputs the transmission data to the narrow pulse generator circuit 12.

In the first embodiment, it is assumed that as the transmission data having a pulse waveform, for example, transmission data of a Non-Return-to-Zero (NRZ) scheme is provided to the data transmitting unit 11.

The narrow pulse generator circuit 12 includes an inverter 12a, a delay device 12b, and an adder 12c.

The narrow pulse generator circuit 12 is a circuit that generates, as a pulse synchronized with a rise of transmission data T having a pulse waveform, a first pulse P1 having a narrower pulse width than a pulse width Tp of the pulse waveform and having a positive signal level.

In addition, the narrow pulse generator circuit 12 is a circuit that generates, as a pulse synchronized with a fall of the transmission data T, a second pulse P2 having a narrower pulse width than the pulse width Tp of the pulse waveform and having a negative signal level.

The inverter 12a is an inverting device that inverts the signal level of the transmission data T outputted from the data transmitting unit 11, and outputs transmission data T′ with the inverted signal level to the delay device 12b.

The delay device 12b holds the transmission data T′ outputted from the inverter 12a for delay time d, and outputs the transmission data T′ held for the delay time d as transmission data T″ to the adder 12c.

The adder 12c adds the transmission data T outputted from the data transmitting unit 11 and the transmission data T″ outputted from the adder 12c, and thereby generates each of a first pulse P1 and a second pulse P2.

The amplifier 13 amplifies each of the first pulse P1 and second pulse P2 generated by the adder 12c.

The amplifier 13 outputs, as differential signals, each of the amplified first pulse P1 and the amplified second pulse P2 to the transmission lines 4a through the output resistors 14.

Each of the output resistors 14 is a resistor connected at its one end to the amplifier 13 and connected at its other end to a corresponding transmission line 4a, and has the same impedance as characteristic impedance of the transmission line 4a.

The signal repeater 2 includes terminating resistors 21, a comparator 22, a narrow pulse generator circuit 23, an amplifier 24, and output resistors 25.

The signal repeater 2 demodulates the transmission data T on the basis of the first pulse P1 and second pulse P2 outputted from the transmitter 1 to the transmission lines 4a.

The signal repeater 2 reproduces the first pulse P1 as a pulse synchronized with a rise of the demodulated transmission data T, and reproduces the second pulse P2 as a pulse synchronized with a fall of the demodulated transmission data T.

The signal repeater 2 outputs each of the reproduced first pulse P1 and the reproduced second pulse P2 to the transmission lines 4b.

Each of the terminating resistors 21is a resistor connected at its one end to a corresponding transmission line 4a and grounded at its other end, and has the same impedance as characteristic impedance of the transmission line 4a.

The comparator 22 demodulates the transmission data T on the basis of the first pulse P1 and second pulse P2 outputted from the transmitter 1 to the transmission lines 4a, and outputs the demodulated transmission data T to the narrow pulse generator circuit 23.

The narrow pulse generator circuit 23 includes an inverter 23a, a delay device 23b, and an adder 23c.

The narrow pulse generator circuit 23 is a circuit that reproduces the first pulse P1 having a narrower pulse width than the pulse width Tp of the pulse waveform and having a positive signal level, as a pulse synchronized with a rise of the transmission data T outputted from the comparator 22.

In addition, the narrow pulse generator circuit 23 is a circuit that reproduces the second pulse P2 having a narrower pulse width than the pulse width Tp of the pulse waveform and having a negative signal level, as a pulse synchronized with a fall of the transmission data T outputted from the comparator 22.

The inverter 23a is an inverting device that inverts the signal level of the transmission data T outputted from the comparator 22 and outputs transmission data T′ with the inverted signal level to the delay device 23b.

The delay device 23b holds the transmission data T′ outputted from the inverter 23a for delay time d, and outputs the transmission data T′ held for the delay time d as transmission data T″ to the adder 23c.

The adder 23c adds the transmission data T outputted from the comparator 22 and the transmission data T″ outputted from the adder 23c, and thereby reproduces each of the first pulse P1 and second pulse P2.

The amplifier 24 amplifies each of the first pulse P1 and second pulse P2 reproduced by the adder 23c.

The amplifier 24 outputs, as differential signals, each of the amplified first pulse P1 and the amplified second pulse P2 to the transmission lines 4b through the output resistors 25.

Each of the output resistors 25 is a resistor connected at its one end to the amplifier 24 and connected at its other end to a corresponding transmission line 4b, and has the same impedance as characteristic impedance of the transmission line 4b.

The receiver 3 includes terminating resistors 31, a comparator 32, and a data receiving unit 33.

The receiver 3 demodulates the transmission data T on the basis of the first pulse P1 and second pulse P2 outputted from the signal repeater 2 to the transmission lines 4b.

Each of the terminating resistors 31 is a resistor connected at its one end to a corresponding transmission line 4b and grounded at its other end, and has the same impedance as characteristic impedance of the transmission line 4b.

The comparator 32 demodulates the transmission data T on the basis of the first pulse P1 and second pulse P2 outputted from the signal repeater 2 to the transmission lines 4b, and outputs the demodulated transmission data T to the data receiving unit 33.

The data receiving unit 33 performs a reception process, etc., on the transmission data T outputted from the comparator 32.

Next, operation of the communication system shown in FIG. 1 will be described.

First, operation of the transmitter 1 will be described.

FIG. 2 is an explanatory diagram showing the waveforms of signals handled by the transmitter 1.

First, when transmission data of the NRZ scheme is provided as transmission data T having a pulse waveform to the data transmitting unit 11, the data transmitting unit 11 outputs the transmission data T to each of the inverter 12a and the adder 12c.

As shown in FIG. 2, the transmission data T is a pulse with the signal level “+1 (“H” level)” or “−1 (“L” level)”.

In an example of FIG. 2, the pulse width of the transmission data T is Tp.

When the inverter 12a receives the transmission data T from the data transmitting unit 11, the inverter 12a inverts the signal level of the transmission data T and outputs, as shown in FIG. 2, transmission data T′ with the inverted signal level to the delay device 12b.

When the delay device 12b receives the transmission data T′ from the inverter 12a, the delay device 12b holds the transmission data T′ for delay time d and outputs, as shown in FIG. 2, the transmission data T′ held for the delay time d as transmission data T″ to the adder 12c.

When the adder 12c receives the transmission data T from the data transmitting unit 11 and receives the transmission data T″ from the delay device 12b, the adder 12c adds the transmission data T and the transmission data T″ and thereby generates each of a first pulse P1 and a second pulse P2.

The pulse width of the first pulse P1 generated by the adder 12c is Tp1, and the pulse width of the second pulse P2 generated by the adder 12c is Tp2. The pulse width Tpl and the pulse width Tp2 are identical pulse widths and narrower pulse widths than the pulse width Tp of the transmission data T.

Each of the pulse width Tpl and the pulse width Tp2 may be any pulse width as long as they are narrower than the pulse width Tp and is, for example, a pulse width equal to or less than one-half of the pulse width Tp.

The adder 12c outputs each of the first pulse P1 and the second pulse P2 to the amplifier 13.

The amplifier 13 amplifies each of the first pulse P1 and second pulse P2 outputted from the adder 12c and outputs, as differential signals, each of the amplified first pulse P1 and the amplified second pulse P2 to the transmission lines 4a through the output resistors 14.

Each of the first pulse P1 and second pulse P2 outputted from the amplifier 13 is transmitted to the signal repeater 2 by the transmission lines 4a.

Here, the amplification factor for a signal in the amplifier 13 is determined based on the attenuation factor of a signal on the transmission lines 4a.

For example, the amplification factor for a signal in the amplifier 13 is determined in such a manner that the “H” level and “L” level of the waveform of a difference between differential signals to be inputted to the signal repeater 2 are approximately the same as the “H” level and “L” level of an input signal to the amplifier 13, respectively.

The input signal to the amplifier 13 indicates each of the first pulse P1 and second pulse P2 outputted from the adder 12c.

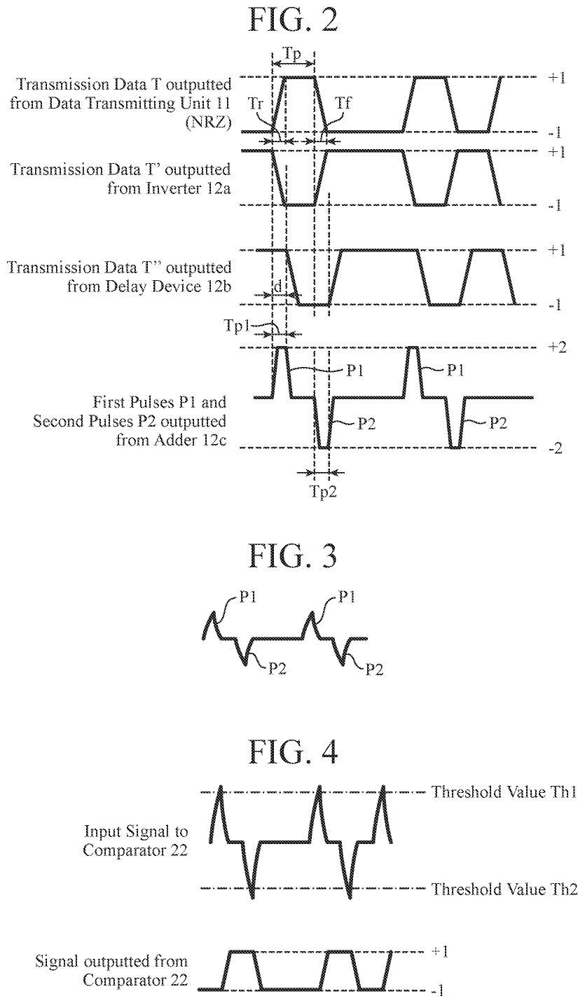

Each of the first pulse P1 and the second pulse P2 has, as shown in FIG. 3, a rounded waveform due to transmission loss on the transmission lines 4a.

FIG. 3 is an explanatory diagram showing first pulses P1 and second pulses P2 having a rounded waveform due to transmission loss on the transmission lines 4a.

The differential signals outputted from the transmitter 1 to the transmission lines 4a are inputted to the comparator 22 of the signal repeater 2.

The comparator 22 demodulates the transmission data T on the basis of the differential signals, and outputs the demodulated transmission data T to the narrow pulse generator circuit 23.

A demodulation process of the transmission data T by the comparator 22 will be specifically described below.

FIG. 4 is an explanatory diagram showing a demodulation process of the transmission data T by the comparator 22.

The comparator 22 is a comparator having hysteresis, and compares the waveform of a difference between differential signals with each of a threshold value Th1 and a threshold value Th2.

The threshold value Th1 is a value smaller than the “H” level of the waveform of a difference between differential signals inputted to the comparator 22 and is, for example, a value greater than 0 and smaller than +2.

The threshold value Th2 is a value larger than the “L” level of the waveform of a difference between differential signals inputted to the comparator 22 and is, for example, a value smaller than 0 and larger than −2.

When the waveform of a difference between differential signals is changed from a state of being equal to or less than the threshold value Th2 to a state of being greater than the threshold value Th1, the comparator 22 outputs a signal with the signal level “+1” to each of the inverter 23a and the adder 23c.

When the waveform of a difference between differential signals is changed to a state of being greater than the threshold value Th1, the comparator 22 thereafter continues to output the signal with the signal level “+1” unless the waveform of a difference between differential signals goes into a state of being smaller than the threshold value Th2.

When the waveform of a difference between differential signals is changed from a state of being equal to or greater than the threshold value Th1 to a state of being smaller than the threshold value Th2, the comparator 22 outputs a signal with the signal level “−1” to each of the inverter 23a and the adder 23c.

When the waveform of a difference between differential signals is changed to a state of being smaller than the threshold value Th2, the comparator 22 thereafter continues to output the signal with the signal level “−1” unless the waveform of a difference between differential signals goes into a state of being greater than the threshold value Th1.

As shown in FIG. 4, a signal outputted from the comparator 22 is transmission data of the NRZ scheme, and corresponds to the transmission data T having a pulse waveform which is provided to the data transmitting unit 11.

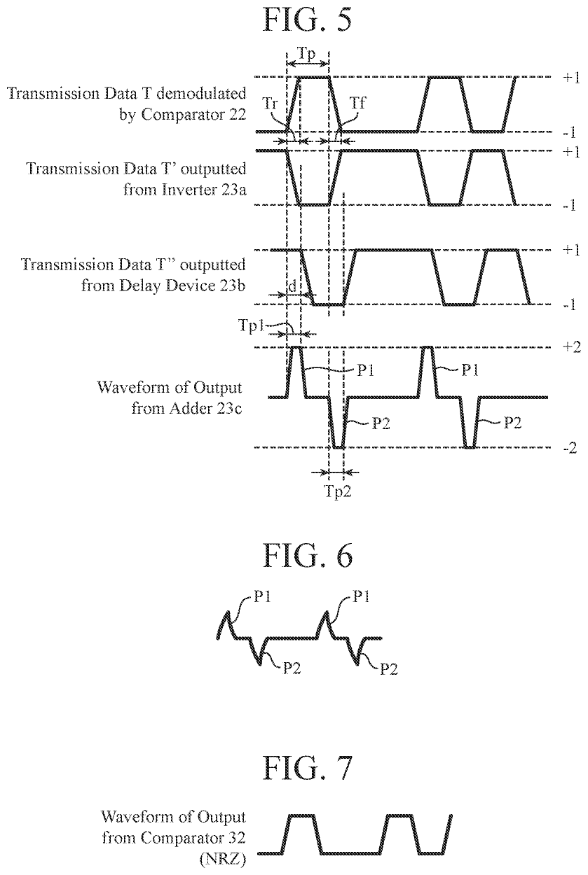

FIG. 5 is an explanatory diagram showing the waveforms of signals handled by the narrow pulse generator circuit 23 of the signal repeater 2.

When the inverter 23a receives the demodulated transmission data T from the comparator 22 the inverter 23a inverts the signal level of the transmission data T and outputs, as shown in FIG. 5, transmission data T′ with the inverted signal level to the delay device 23b.

When the delay device 23b receives the transmission data T′ from the inverter 23a, the delay device 23b holds the transmission data T′ for delay time d and outputs, as shown in FIG. 5, the transmission data T′ held for the delay time d as transmission data T″ to the adder 23c.

When the adder 23c receives the demodulated transmission data T from the comparator 22 and receives the transmission data T″ from the delay device 23b, the adder 23c adds the transmission data T and the transmission data T″ and thereby generates each of a first pulse P1 and a second pulse P2.

The pulse width of the first pulse P1 generated by the adder 23c is Tp1, and the pulse width of the second pulse P2 generated by the adder 23c is Tp2. The pulse width Tp1 and the pulse width Tp2 are identical pulse widths and narrower pulse widths than the pulse width Tp of the transmission data T.

Each of the pulse width Tp1 and the pulse width Tp2 may be any pulse width as long as they are narrower than the pulse width Tp and is, for example, a pulse width equal to or less than one-half of the pulse width Tp.

The adder 23c outputs each of the first pulse P1 and the second pulse P2 to the amplifier 24.

The amplifier 24 amplifies each of the first pulse P1 and second pulse P2 outputted from the adder 23c and outputs, as differential signals, each of the amplified first pulse P1 and the amplified second pulse P2 to the transmission lines 4b through the output resistors 25.

Each of the first pulse P1 and second pulse P2 outputted from the amplifier 24 is transmitted to the receiver 3 by the transmission lines 4b.

Here, the amplification factor for a signal in the amplifier 24 is determined based on the attenuation factor of a signal on the transmission lines 4b.

For example, the amplification factor for a signal in the amplifier 24 is determined in such a manner that the “H” level and “L” level of the waveform of a difference between differential signals to be inputted to the receiver 3 are approximately the same as the “H” level and “L” level of an input signal to the amplifier 24, respectively.

The input signal to the amplifier 24 indicates each of the first pulse P1 and second pulse P2 outputted from the adder 23c.

Each of the first pulse P1 and the second pulse P2 has, as shown in FIG. 6, a rounded waveform due to transmission loss on the transmission lines 4b.

FIG. 6 is an explanatory diagram showing first pulses P1 and second pulses P2 having a rounded waveform due to transmission loss on the transmission lines 4b.

The differential signals outputted from the signal repeater 2 to the transmission lines 4b are inputted to the comparator 32 of the receiver 3.

The comparator 32 demodulates the transmission data T on the basis of the differential signals, and outputs the demodulated transmission data T to the data receiving unit 33.

FIG. 7 is an explanatory diagram showing the transmission data T outputted from the comparator 32.

As shown in FIG. 7, a signal outputted from the comparator 32 is transmission data of the NRZ scheme, and corresponds to the transmission data T having a pulse waveform which is provided to the data transmitting unit 11.

A demodulation process performed by the comparator 32 is the same as the demodulation process performed by the comparator 22 and thus a detailed description thereof is omitted.

In the above-described first embodiment, the communication system is configured to include the signal repeater 2 that demodulates transmission data on the basis of a first and a second pulse outputted from the transmitter 1 to the transmission lines 4a, reproduces the first pulse as a pulse synchronized with a rise of the demodulated transmission data, reproduces the second pulse as a pulse synchronized with a fall of the demodulated transmission data, and outputs each of the reproduced first pulse and the reproduced second pulse to the transmission lines 4b. Therefore, the communication system of the first embodiment can reduce erroneous demodulation of signals even if the line length of a transmission line between the transmitter 1 and the receiver 3 is increased.

The signal repeater 2 included in the communication system of the first embodiment does not compensate for transmission loss by including an equalizer circuit having gain appropriate to handle transmission loss on a transmission line. Therefore, the communication system of the first embodiment can reduce erroneous demodulation of signals even if accurate gain appropriate to handle transmission loss on a transmission line cannot be grasped in advance.

In the communication system of the first embodiment, an exemplary configuration in which the narrow pulse generator circuit 12 includes the inverter 12a, the delay device 12b, and the adder 12c is shown. In addition, an exemplary configuration in which the narrow pulse generator circuit 23 includes the inverter 23a, the delay device 23b, and the adder 23c is shown.

However, the configurations of each of the narrow pulse generator circuit 12 and the narrow pulse generator circuit 23 are not limited to the configurations shown in FIG. 1.

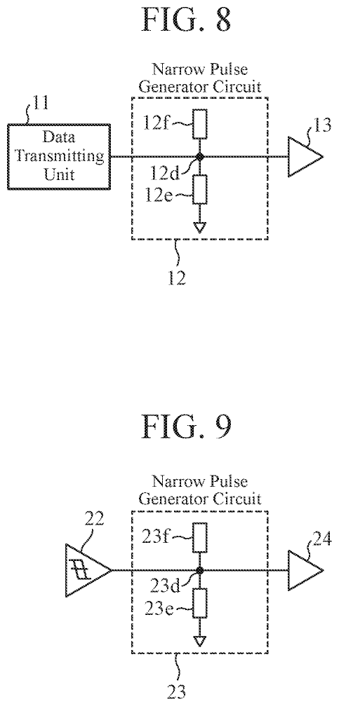

For example, the narrow pulse generator circuit 12 may have a configuration such as that shown in FIG. 8. In addition, the narrow pulse generator circuit 23 may have a configuration such as that shown in FIG. 9.

FIG. 8 is a configuration diagram showing another narrow pulse generator circuit 12 of the transmitter 1.

FIG. 9 is a configuration diagram showing another narrow pulse generator circuit 23 of the signal repeater 2.

In an example of FIG. 8, the narrow pulse generator circuit 12 includes a short stub 12e connected at its one end to a connecting point 12d between an output side of the data transmitting unit 11 and an input side of the amplifier 13; and an open stub 12f connected at its one end to the connecting point 12d.

The narrow pulse generator circuit 12 shown in FIG. 8 can also generate each of a first pulse P1 and a second pulse P2 as with the narrow pulse generator circuit 12 shown in FIG. 1.

Each of the line length Ls1 of the short stub 12e and the line length Lo1 of the open stub 12f is determined, for example, from the rise time Tr of transmission data T outputted from the data transmitting unit 11 and the effective relative permittivity ε_{reff1} of each of the short stub 12e and the open stub 12f as shown in equation (1).

$$Ls 1 = Lo 1 = \frac{Tr}{4} \times \frac{c}{\sqrt{{ɛ}_{reff 1}}} \qquad ( 1 )$$

In equation (1), “c” is the speed of light.

In an example of FIG. 9, the narrow pulse generator circuit 23 includes a short stub 23e connected at its one end to a connecting point 23d between an output side of the comparator 22 and an input side of the amplifier 24; and an open stub 23f connected at its one end to the connecting point 23d.

The narrow pulse generator circuit 23 shown in FIG. 9 can also reproduce each of a first pulse P1 and a second pulse P2 as with the narrow pulse generator circuit 23 shown in FIG. 1.

Each of the line length Ls2 of the short stub 23e and the line length Lo2 of the open stub 23f is determined, for example, from the rise time Tr of a signal outputted from the comparator 22 and the effective relative permittivity ε_{reff2} of each of the short stub 23e and the open stub 23f as shown in equation (2).

$$Ls 2 = Lo 2 = \frac{Tr}{4} \times \frac{c}{\sqrt{{ɛ}_{reff 2}}} \qquad ( 2 )$$

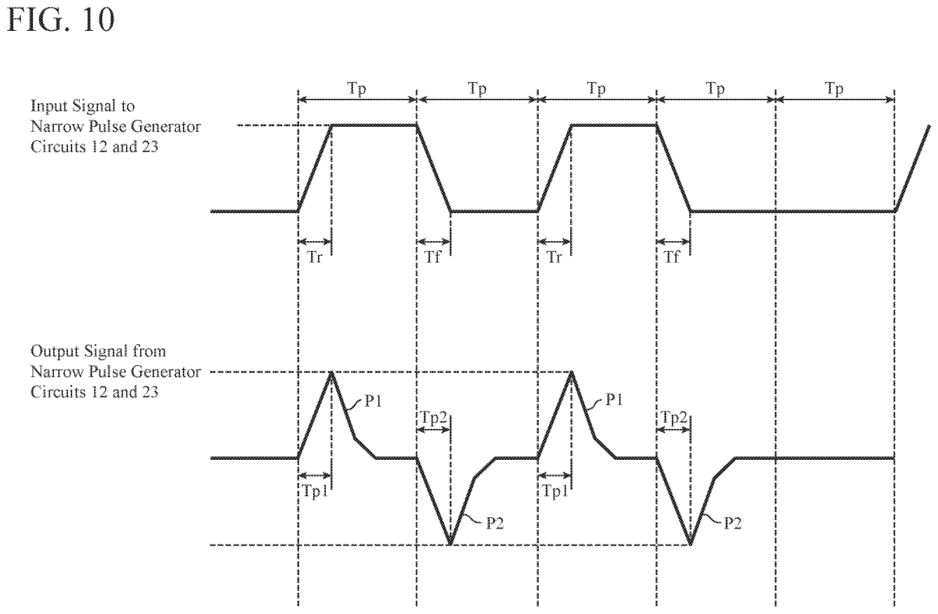

FIG. 10 is an explanatory diagram showing the waveform of an input signal and the waveform of an output signal at each of the narrow pulse generator circuit 12 and the narrow pulse generator circuit 23.

As shown in FIG. 10, each of the narrow pulse generator circuit 12 and the narrow pulse generator circuit 23 can generate each of first pulses P1 and second pulses P2.

### Second Embodiment.

The first embodiment shows a communication system in which one signal repeater 2 is inserted in the middle of a transmission line that connects the transmitter 1 to the receiver 3.

A second embodiment describes a communication system in which a plurality of signal repeaters 2 are inserted in the middle of a transmission line that connects the transmitter 1 to the receiver 3.

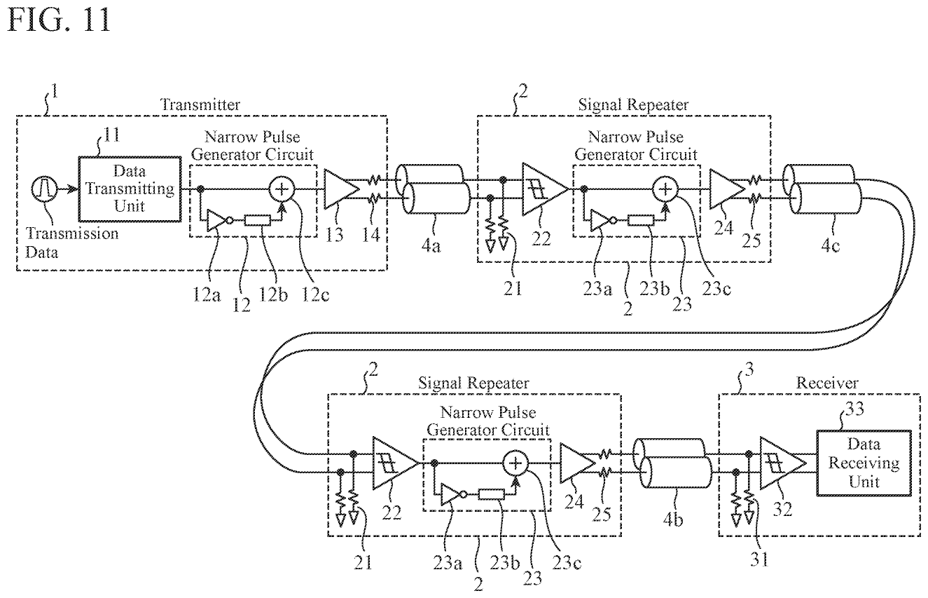

FIG. 11 is a configuration diagram showing a communication system of the second embodiment.

Although an example in which two signal repeaters 2 are inserted in the middle of a transmission line that connects the transmitter 1 to the receiver 3 is shown in the communication system shown in FIG. 11, three or more signal repeaters 2 may be inserted.

In FIG. 11, the same reference signs as those in FIG. 1 indicate the same or corresponding portions and thus description thereof is omitted.

Transmission lines 4c connect two signal repeaters 2.

For the transmission lines 4c, as with the transmission lines 4a and the transmission lines 4b, metal cables, printed circuit board wiring, or the like, are applied.

The two signal repeaters 2 each are the same signal repeater as the signal repeater 2 of the first embodiment.

Note, however, that of the two signal repeaters 2, a signal repeater 2 on a side closer to the receiver 3 demodulates transmission data T on the basis of a first pulse P1 and a second pulse P2 which are outputted to the transmission lines 4c from a signal repeater 2 on a side closer to the transmitter 1 which is another signal repeater present at a previous stage.

The signal repeaters 2 are devices inserted in the middle of the transmission line to prevent transmission loss on the transmission line from increasing to the extent that the receiver 3 cannot accurately demodulate a signal.

Therefore, the line length of a transmission line between the transmitter 1 and the receiver 3 can be increased by increasing the number of signal repeaters 2 inserted in the middle of the transmission line.

In a signal transmission scheme of the first and second embodiments, a signal relay is successively performed within a range in which inter-symbol interference caused by loss on the transmission line does not occur. Therefore, the signal transmission scheme of the first and second embodiments enables, in principle, long-distance data transmission without causing a data error even if the number of signal repeaters 2 is increased.

Note that in the invention of the present application, a free combination of the embodiments, modifications to any component of the embodiments, or omissions of any component in the embodiments are possible within the scope of the invention.

### INDUSTRIAL APPLICABILITY

The invention is suitable for a communication system in which a signal repeater is inserted in the middle of a transmission line that connects a transmitter to a receiver.

In addition, the invention is suitable for a signal repeater inserted in the middle of a transmission line that connects a transmitter to a receiver.

### REFERENCE SIGNS LIST

1: transmitter,
2: signal repeater,
3: receiver,
4a, 4b, and 4c: transmission line,
11: data transmitting unit,
12: narrow pulse generator circuit,
12a: inverter,
12b: delay device,
12c: adder,
12d: connecting point,
12e: short stub,
12f: open stub,
13: amplifier,
14: output resistor,
21: terminating resistor,
22: comparator,
23: narrow pulse generator circuit,
23a: inverter,
23b: delay device,
23c: adder,
23d: connecting point,
23e: short stub,
23f: open stub,
24: amplifier,
25: output resistor,
31: terminating resistor,
32: comparator, and
33: data receiving unit

1. A communication system in which a signal repeater is inserted in a middle of a transmission line that connects a transmitter to a receiver, wherein
the transmitter generates, as a pulse synchronized with a rise of transmission data having a pulse waveform, a first pulse having a narrower pulse width than a pulse width of the pulse waveform and having a positive signal level, generates, as a pulse synchronized with a fall of the transmission data, a second pulse having a narrower pulse width than the pulse width of the pulse waveform and having a negative signal level, and outputs each of the first pulse and the second pulse to the transmission line,
the signal repeater demodulates the transmission data on a basis of the first and second pulses outputted from the transmitter to the transmission line, reproduces the first pulse as a pulse synchronized with a rise of the demodulated transmission data, reproduces the second pulse as a pulse synchronized with a fall of the demodulated transmission data, amplifies each of the reproduced first pulse and the reproduced second pulse, and outputs each of the amplified first pulse and the amplified second pulse to the transmission line, and
the receiver demodulates the transmission data on a basis of the first and second pulses outputted from the signal repeater to the transmission line.

2. The communication system according to claim 1, wherein
a plurality of signal repeaters are inserted in the middle of the transmission line, and
of the plurality of signal repeaters, a signal repeater to which another signal repeater is connected at a previous stage demodulates the transmission data on a basis of a first and a second pulse outputted from the another signal repeater to the transmission line.

3. A signal repeater comprising:
a comparator connected, through a transmission line, to a transmitter for generatingto generate, as a pulse synchronized with a rise of transmission data having a pulse waveform, a first pulse having a narrower pulse width than a pulse width of the pulse waveform and having a positive signal level, and to generate, as a pulse synchronized with a fall of the transmission data, a second pulse having a narrower pulse width than the pulse width of the pulse waveform and having a negative signal level, the comparator demodulating the transmission data on a basis of the first and second pulses outputted from the transmitter to the transmission line;
a narrow pulse generator circuit to reproduce the first pulse as a pulse synchronized with a rise of the transmission data demodulated by the comparator, reproducing the second pulse as a pulse synchronized with a fall of the demodulated transmission data, and
an amplifier to amplify each of the first pulse reproduced by the narrow pulse generator circuit and the second pulse reproduced by the narrow pulse generator circuit, and to output each of the amplified first pulse and the amplified second pulse to a receiver through a transmission line.
